(19) United States
(12) Patent Application Publication
(10) Pub. No.: US 2021/0039777 A1
(43) Pub. Date: Feb. 11, 2021

(54) ELECTRIC TIP-JET ENGINES FOR AIRCRAFT ROTORS

(71) Applicant: ETJET LTD., Asseret (IL)

(72) Inventor: Eliyahu GAMZON, Bet-Oved (IL)

(73) Assignee: ETJet Ltd, Asseret (IL)

(21) Appl. No.: 16/976,755

(22) PCT Filed: Sep. 15, 2019
(86) PCT No.: PCT/IB2019/057761

§ 371 Date: Aug. 30, 2020

Related U.S. Application Data
(60) Provisional application No. 62/731,984, filed on Sep. 17, 2018.

(51) Int. Cl. B64C 27/18; B64D 27/24

(52) U.S. Cl. CPC B64C 27/18; B64D 27/24

(57) ABSTRACT

An electrically-powered tip-jet engine system for turning an aircraft rotor blade comprises first and second fan assemblies having substantially the same moment of inertia and configured to rotate at the same angular speed, each fan assembly comprising a respective plurality of fan blades and a respective electric motor rotor; and a rigid frame assembly comprising an electric motor stator assembly and configured for mounting to the aircraft rotor blade. The first fan assembly is effective to create thrust in a thrust direction by rotating clockwise with respect to the thrust direction, and the second fan assembly is effective to create thrust in the thrust direction by rotating counter-clockwise with respect to the thrust direction. The rotation in opposing directions of the first and second fan assemblies is effective to eliminate gyroscopic effect on the aircraft rotor blade.

### CROSS-REFERENCE TO RELATED APPLICATIONS

This patent application claims the benefit of U.S. Provisional Patent Application No. 62/731,984 filed on Sep. 17, 2018, which is incorporated herein by reference in its entirety.

### FIELD OF THE INVENTION

The present invention relates to electric tip-jet engines for powering rotary-wing and VTOL fixed-wing aircraft, and particularly to systems and methods that eliminate the potential of gyroscopic effect caused by electric fans and electric motor components spinning on the rotor blades.

### BACKGROUND

A growing market for urban and interurban point-to-point ‘flying taxi’ or ‘flying car’ service requires efficient, non-polluting and quiet aircraft. Concepts have been proposed for electrically-powered rotary-wing aircraft, i.e., single- and multi-rotor helicopters, as well as VTOL fixed-wing aircraft with multiple rotors. A classical Tip Jet helicopter is designed as having a propulsion device installed at the tips of its rotor, applying thrust perpendicular to the rotor-blade, torqueing it and supplying the energy needed to hover, climb or fly forward. Since the torque is applied directly to the rotor and not originated from the helicopter fuselage, there is no counter-torque applied on the fuselage and there is no need for a tail-rotor (or a tail).

In addition, the main rotor transmission is not needed, and for a battery powered helicopter there is no need for main-engine installed in the fuselage. The whole propulsion system of an aircraft that could employ a electric tip-jet system consists of a battery pack and a number of electric-tip-jet-engines equal to the number of rotor blades. All this reduces the empty-weight of the helicopter, allows more weight for the batteries and increases the payload or the endurance of the vehicle.

A simple electric tip-jet will have a fan turned by an electric motor typically spinning at a rate of 10,000-15,000 RPM. If mounted at a tip of a rotor-blade turning at a rate of 300-600 RPM, a very large gyroscopic moment will develop, applying a twist moment around the rotor-blade longitudinal axis, and probably destroying the rotor. Thus, there is a need for an electric tip-jet solution for turning aircraft rotors without the disadvantage of the gyroscopic effect.

### SUMMARY

According to embodiments of the invention, an electrically-powered tip-jet engine system for turning an aircraft rotor blade comprises: (a) first and second fan assemblies having substantially the same moment of inertia and configured to rotate at the same angular speed, each fan assembly comprising a respective plurality of fan blades and a respective electric motor rotor; and (b) a rigid frame assembly comprising an electric motor stator assembly and configured for mounting to the aircraft rotor blade, wherein (i) the first fan assembly is effective to create thrust in a thrust direction by rotating clockwise with respect to the thrust direction, and (ii) the second fan assembly is effective to create thrust in the thrust direction by rotating counter-clockwise with respect to the thrust direction.

In some embodiments, the rotation in opposing directions of the first and second fan assemblies can be effective to eliminate gyroscopic effect on the aircraft rotor blade.

In some embodiments, the first and second fan assemblies can be disposed such that the respective motor rotors are adjacent to, and located on opposite sides of, the stator assembly, the stator assembly being configured as a common stator assembly for both fan assemblies.

In some embodiments, the tip-jet engine system can comprise two stator assemblies, each stator assembly being disposed adjacent to a respective one of the first and second fan assemblies so as to form respective first and second electric motor units.

In some embodiments, the first and second fan assemblies can be arranged coaxially.

In some embodiments, the tip-jet engine system can additionally comprise a static guide-vane ring installed between the first and second fan assemblies. In some embodiments, the respective pluralities of fan blades are configured to operate together as a two-stage counter-rotating axial fan.

In some embodiments, the first and second motor units can be configured to be arranged side-by-side when mounted to the aircraft rotor blade. In some embodiments, the first and second motor units can be configured to be arranged substantially one atop the other when mounted to the aircraft rotor blade.

In some embodiments, the fan assemblies can be ducted.

According to embodiments, an aircraft configured to carry passengers comprises: (a) an onboard electrical power source; an aircraft rotor comprising a plurality of aircraft rotor blades; and a plurality of electrically-powered tip-jet engine systems for turning the aircraft rotor, each tip-jet engine system comprising: (i) a rigid frame assembly mounted to a respective aircraft rotor blade and comprising an elctric motor stator assembly, and (ii) first and second fan assemblies having substantially the same moment of inertia and configured to rotate at the same angular speed, each fan assembly comprising a respective plurality of fan blades and a respective electric motor rotor, wherein (A) the first fan assembly is effective to create thrust in a thrust direction by rotating clockwise with respect to the thrust direction, and (B) the second fan assembly is effective to create thrust in the thrust direction by rotating counter-clockwise with respect to the thrust direction.

In some embodiments, the aircraft can be a helicopter. In some embodiments, the aircraft can be a VTOL fixed-wing aircraft.

In some embodiments, the aircraft can additionally comprise: (d) a plurality of electrically conductive wires, each respective wire disposed in an aircraft rotor blade for delivering electricity to the tip-jet engine system; and (e) a slip ring connected to the aircraft rotor for transmitting electric power from the power source to the plurality of wires.

In some embodiments, the rotation in opposing directions of the first and second fan assemblies of each tip-jet engine system can be effective to eliminate gyroscopic effect on the respective aircraft rotor blade.

In some embodiments, the first and second fan assemblies of each tip-jet engine system can be disposed such that the respective motor rotors are adjacent to and on opposite sides of the stator assembly, the stator assembly being configured as a common stator assembly for both the first and second fan assemblies.

In some embodiments, it can be that (i) each tip-jet engine system comprises two stator assemblies, and (ii) each stator assembly is disposed adjacent to a respective one of the first and second fan assemblies of the respective tip-jet engine system so as to form respective first and second electric motor units.

In some embodiments, the first and second fan assemblies of each tip-jet engine system can be arranged coaxially.

In some embodiments, each tip-jet engine system can additionally comprise a static guide-vane ring installed between the respective first and second fan assemblies.

In some embodiments, the respective pluralities of fan blades of the first and second fan assemblies of each tip-jet engine system can be configured to operate together as a two-stage counter-rotating axial fan.

In some embodiments, the first and second motor units of each tip-jet engine system can be arranged side-by-side. In some embodiments, the first and second motor units of each tip-jet engine system can be arranged substantially one atop the other.

In some embodiments, it can be that the fan assemblies of at least one of the plurality of tip-jet engines are ducted.

A method is disclosed for operating an aircraft comprising a plurality of electrically-powered tip-jet engine systems mounted to respective rotor blades of the aircraft, each tip-jet engine system comprising first and second fan assemblies, the method comprising: (a) delivering electric power from on onboard source to the plurality of tip-jet engine systems; (b) causing respective first fan assemblies of the tip-jet engine systems to rotate clockwise with respect to respective thrust directions and thereby create thrust in the thrust directions; and (c) causing respective second fan assemblies of the tip-jet engine systems to rotate counter-clockwise with respect to the thrust directions and thereby create thrust in the thrust directions, wherein the respective first and second fan assemblies of each tip-jet engine system have substantially the same moment of inertia and rotate at substantially the same angular speed.

In some embodiments, it can be that each of the fan assemblies (i) comprises a respective plurality of fan blades and a respective electric motor rotor, and (ii) is disposed adjacent to an electric motor stator assembly which is mounted to a respective aircraft rotor blade.

In some embodiments, the aircraft can be a helicopter. In some embodiments, the aircraft can be a VTOL fixed-wing aircraft.

In some embodiments, the aircraft can additionally comprise: (a) an onboard electrical power source; (b) a plurality of electrically conductive wires respectively disposed in aircraft rotor blades for delivering the electric power to the tip-jet engine systems; and (c) a slip ring connected to the aircraft rotor for transmitting the electric power from the power source to the plurality of wires.

In some embodiments, the rotating in opposing directions by the first and second fan assemblies of each tip-jet engine system can eliminate gyroscopic effect on the respective aircraft rotor blades.

In some embodiments, the first and second fan assemblies of each tip-jet engine system can be disposed such that the respective motor rotors are adjacent to and on opposite sides of the stator assembly, the stator assembly being configured as a common stator assembly for both the first and second fan assemblies.

In some embodiments, it can be that (i) each tip-jet engine system comprises two stator assemblies, and (ii) each stator assembly is disposed adjacent to a respective fan assembly so as to form respective first and second electric motor units.

In some embodiments, the first and second fan assemblies of each tip-jet engine system can be arranged coaxially.

In some embodiments, each tip-jet engine system can additionally comprise a static guide-vane ring installed between the respective first and second fan assemblies.

In some embodiments, the respective pluralities of fan blades of the first and second fan assemblies can be configured to operate together as a two-stage counter-rotating axial fan.

In some embodiments, the first and second motor units of each tip-jet engine system can be arranged side-by-side. In some embodiments, the first and second motor units of each tip-jet engine system can be arranged substantially one atop the other.

In some embodiments, it can be that the fan assemblies of at least one of the plurality of tip-jet engines are ducted.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. Also, in some drawings the relative sizes of objects, and the relative distances between objects, may be exaggeratedly large or small for the sake of convenience and clarity of presentation. In the drawings:

FIG. 1 is a schematic drawing of a helicopter comprising electrically-powered tip-jet engine systems according to embodiments of the present invention.

FIG. 2 is a schematic drawing of a set of rotor blades of a helicopter comprising electrically-powered tip-jet engine systems, illustrating tip-jet-engine thrust directions and main-rotor rotation direction, according to embodiments of the present invention.

FIG. 3 is a schematic cross-sectional view of an electrically-powered tip-jet engine system comprising two counter-rotating fan assemblies and a common stator, according to embodiments of the present invention.

FIGS. 4 and 5 are two schematic cross-sectional views of electrically-powered tip-jet engine systems, each one comprising two counter-rotating motor units, according to embodiments of the present invention.

FIGS. 6 and 7 are schematic drawings of helicopters comprising electrically-powered tip-jet engine systems arranged, respectively, side-by-side and one atop the other, according to embodiments of the present invention.

FIG. 8 shows a flowchart of a method for operating an aircraft comprising a plurality of electrically-powered tip-jet engine systems, according to embodiments of the present invention.

### DETAILED DESCRIPTION OF THE ILLUSTRATED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements.

Note: Throughout this disclosure, subscripted reference numbers (e.g., 10₁ or 10_{A}) may be used to designate multiple separate appearances of elements of a single species, whether in a drawing or not; for example: 10₁ is a single appearance (out of a plurality of appearances) of element 10. The same elements can alternatively be referred to without subscript (e.g., 10 and not 10₁) when not referring to a specific one of the multiple separate appearances, i.e., to the species in general.

For convenience, in the context of the description herein, various terms are presented here. To the extent that definitions are provided, explicitly or implicitly, here or elsewhere in this application, such definitions are understood to be consistent with the usage of the defined terms by those of skill in the pertinent art(s). Furthermore, such definitions are to be construed in the broadest possible sense consistent with such usage.

The embodiments herein are equally applicable to all kinds of aircraft which use a rotor, e.g., spinning in a roughly horizontal plane for lift and/or hovering and, optionally, for forward propulsion and maneuvering, and the use of the term ‘helicopter’ should be interpreted to encompass any and all such aircrafts for the purposes of understanding the scope of the present invention. The present disclosure uses the terms ‘helicopters’ and VTOL (vertical take-off and landing) aircraft. A helicopter is also a type of VTOL aircraft and any semantic distinction does not limit the present invention in any way. The term ‘helicopter’ as used herein can mean rotary-wing aircraft (rotorcraft) including traditional helicopters or multi-lift-rotorcraft such as quadricopters (also known as quadcopters), or it can mean any rotor-equipped aircraft including a VTOL aircraft. The term ‘VTOL’ as used herein means only VTOL aircraft other than helicopters, such as fixed-wing aircraft with one or more lift rotors, or tilt-rotor aircraft.

The terms ‘tip-jet’ and ‘tip-jet engine’ are used broadly to encompass devices for vehicles adapted for flight using rotors, where the lift of the rotor blades is accomplished by creating thrust at or near the distal tips of the rotor blades, whether by actual ‘jets’ or not. The term ‘stator assembly’ is intended to include at least the stator and any magnets or electromagnetic windings (or coils) provided within.

The term ‘fan assembly’ as used herein means a rotatable assembly comprising a fan, or a plurality of fan blades, and the rotor of an electric motor. The terms ‘fan’ and ‘fan assembly’ should be regarded as including propellers and propeller blades substituting for fans and fan blades in the case of an engine design without a duct shell. The term ‘motor unit’ as used herein means a combination of a fan assembly with an electric motor stator. In other words, a ‘motor unit’ as defined herein comprises at least the two key components of an electric motor (stator and rotor) along with a fan or a plurality of fan blades. A ‘rigid frame assembly’ as used herein means a rigid frame suitable for mounting a tip-jet engine system to the rotor blade of an aircraft, where the frame comprises a stationary component of an electric motor of the tip-jet engine system, such as, without limitation, a stator or stator assembly.

The term ‘tip-jet engine system’ as used herein means a tip-jet engine mounted on a rotor blade, or multiple tip-jet engines mounted on a single rotor blade so as to operate together. It is to be understood that a tip-jet engine system includes an electric motor, a fan assembly which may include a cowling for aerodynamics and/or equipment protection, a fan duct in those embodiments in which the fan assembly/tip-jet engine is ducted, a guide vane ring in those embodiments in which multiple coaxial fan assemblies or motor units are assembled in a fan duct, and a rigid frame mounting the tip-jet engine system to the aircraft rotor blade.

According to embodiments of the invention, an electrically-powered tip-jet engine uses an electric motor to generate torque in an aircraft rotor, in order to spin a fan connected to the aircraft rotor. The electrically-powered tip-jet engine is preferably positioned to create thrust at or near the distal tips of a rotor blade. The attached figures all illustrate, for convenience, brushless direct current (DC) motors built with an outer-rotor design, the motors all illustrated as having electromagnetic coils in a stator assembly and external permanent magnets in a rotor. This is not meant to exclude other types of suitable motors for electrically-powered tip-jet engines according to the embodiments of the present invention; in other examples which are not illustrated, the electric motors of the tip-jet engine can include, and not exhaustively, alternating current (AC) induction motors, switched reluctance motors or other designs of brushless DC motors. Non-limiting examples of other suitable DC motors include those with permanent magnets in the stator assembly and electromagnetic windings in the rotor(s). Permanent magnets in the rotor can be external or internal to the rotors.

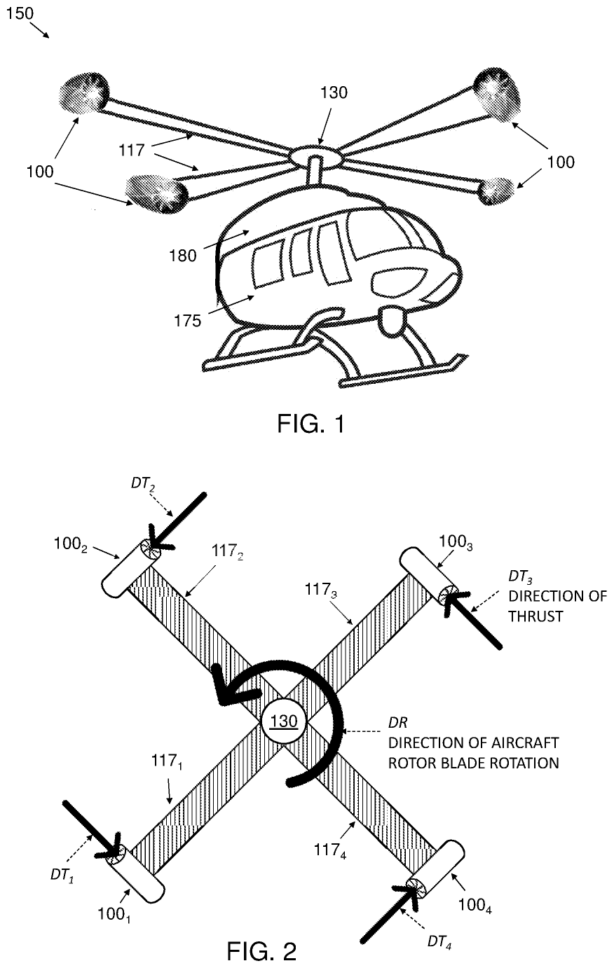

Referring now to the figures, FIG. 1 shows a schematic diagram of a non-limiting example of a tip-jet helicopter 150. The helicopter 150 of FIG. 1 has a passenger cabin 175 and four rotor blades 117 connected to aircraft rotor 130. Nearly any number of rotor blades can be suitable for operation of a tip-jet helicopter, although it is most practical to have at least two and not more than six to eight. A tip-jet engine system 100 is provided at or near the distal end of each rotor blade 117 or at least in the distal half of each rotor blade 117. The size of the passenger cabin depends on the overall specification of the helicopter, including, inter alia, the weight and size, power capabilities of the tip-jet engines, number, size and angular speed of the aircraft's rotor blades, and type and size of the power source.

An electrically-powered helicopter is powered from an onboard power source 180 that can be flown by the helicopter 150 and that contributes to the total weight of the aircraft. The position shown in FIG. 1 for power source 180 is for illustration purposes and in practice the power source can be anywhere on board the vehicle 150. In some embodiments, the power source comprises a rechargeable storage battery pack provided onboard the aircraft. The battery can employ any battery technology with a desirable tradeoff between power density (e.g., kW/kg) and energy density (kWh/kg), such as, in a non-limiting example, a lithium-ion battery technology. In addition to gravimetric power and energy densities, volumetric densities may also come into play in the selection of the battery technology. In some embodiments, a battery pack can include more than one battery technology, for example to combine energy and power characteristics. A battery pack can also include an ultra-capacitor for very rapid power gradients. In some embodiments, the power source can comprise a combustion engine, e.g., a reciprocating engine, provided aboard the aircraft and configured to act as a generator (or alternator, depending on the selection and configuration of the electric motor of tip-jet engine systems). In such embodiments, a fuel tank and supply of fuel are also provided. In some embodiments, an energy storage device such as a battery or ultra-capacitor can be provided as an intermediary between the combustion engine and the tip-jet engine systems, for example to facilitate using a smaller and lighter combustion engine with a lower power output. As is known in the art, the selection of the power source can be based on, inter alia, cost, efficiency, noise, weight and volume. The provision of any suitable power source is within the scope of the embodiments disclosed herein, and the question of the specific technology choice is of no consequence. An onboard power source can also include power electronics equipment, including some or all of, without limitation, AC-DC or DC-AC converters (e.g., inverters or rectifiers), voltage converters (e.g., transformers), power conditioning equipment, distribution panels, surge protection (circuit breakers, etc.), battery charging circuits, and a power control system. Connection of a power source 180 with each of the electric tip-jet engine systems 100 is accomplished using a slip ring (not shown). A slip ring is an electromechanical device as is well known in the art, which allows the transmission of power and electrical signals from a stationary to a rotating structure. The slip ring is installed so as to be in connection with the rotor 130. Electrically conductive wires (not shown) extend from the slip ring through the interior space of the rotor blades 117 to connect to the tip-jet engine systems 100.

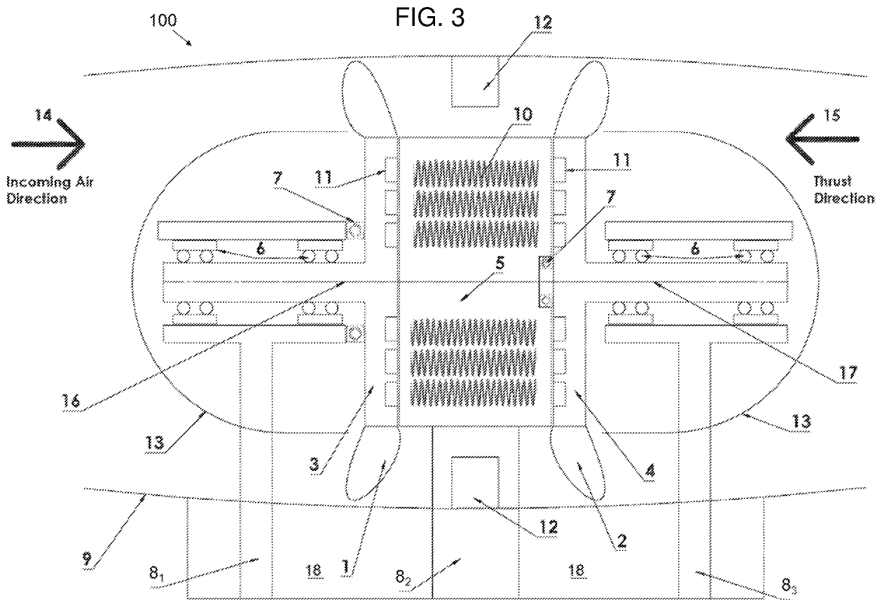

FIG. 2 is a schematic illustration showing how thrust created at the tip-jet engine systems causes rotation of the rotor blades of a helicopter. The helicopter (not shown, except for rotor blades 117) has 4 rotor blades 117₁ . . . 117₄ extending laterally from rotor 130. At the distal end of each rotor blade 117₁ . . . 117₄ is a respective tip-jet engine system 110₁ . . . 100₄. An electric tip-jet engine has a fan that creates a pressure differential by compressing incoming air as it passes through the engine, and the pressure differential creates a thrust force that moves the engine in a thrust direction. The thrust direction of each of the respective tip-jet engine systems 100₁ . . . 100₄ is indicated by the arrows DT₁ . . . DT₄. A thrust direction DT is the direction in which the tip-engine system 100 travels when under power. In the illustrated configuration, the thrust direction DT is orthogonal to the corresponding rotor blade 117, and tangential to an arc described by the movement of the tip-jet engine system 100. The thrust thus created at the tips of the rotor blades 117 causes the rotor blades 117 to spin in the direction of aircraft rotor blade rotation indicated by the arrow DR. The selection of the thrust directions DT which create counter-clockwise rotation of the rotor blades 117 as shown in FIG. 2 is a non-limiting example. In other examples, rotor blades spin clockwise from thrust created (by tip-jet engine systems with reversed orientations) in the directions opposite to the respective thrust directions DT.

As discussed hereinabove, previous attempts to use the electrically-powered tip-jet engine concept have encountered the problem of a large gyroscopic moment developing so as to apply a twist moment around the longitudinal axis of each of the rotor blades. The gyroscopic effect is due to the spinning of a tip-jet fan engine system at a high rotational speed at or near the tips of the spinning rotor blades. The gyroscopic moment is equal to angular momentum of the rotating body (the fan assembly including electric motor rotor components)—which is the moment of inertia of the rotating body multiplied by its angular velocity—multiplied by the angular velocity of the rotor blade. This gyroscopic effect can be serious enough to damage or even destroy the rotor. In the embodiments disclosed herein, the gyroscopic effect is eliminated, or ‘zeroed-out’, or simply not created, due to the provision of a second fan (i.e., fan assembly) on each rotor blade. The moment of inertia and angular spin of the second fan assembly can be set so that the product (angular momentum) is the same, but with a different sign because the direction of the velocity vector is reversed. The angular speed of the aircraft rotor is treated as a constant in this discussion. It can be desirable to establish that angular momentum is substantially the same for the two fan assemblies on each rotor blade by configuring the fan assemblies to have substantially the same moment of inertia, and to rotate (e.g., to be configured to rotate) at the same angular speed. Obviously, the angular velocities are in opposite directions and so it is angular speed, the directionless scalar value of angular velocity, that is set as equal. In some embodiments, angular momentum of both fan assemblies is kept constant so as to eliminate the gyroscopic effect, but the two factors of angular momentum, i.e., angular speed and moment of inertia, are not. According to embodiments, each respective second fan assembly has substantially the same moment of inertia and rotates (or is configured to rotate) at the same angular speed (e.g., in revolutions per minute, or RPM) as the corresponding first fan assembly of a given tip-jet engine system—but in the opposite direction, and no gyroscopic ‘effect’, i.e., gyroscopic moment, is created by the spinning fan assemblies.

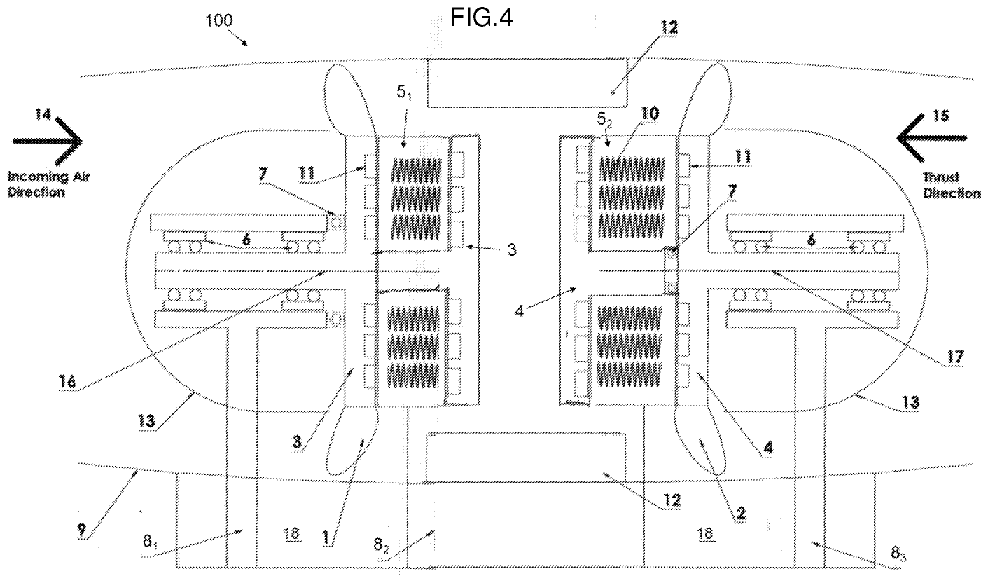

We now refer to FIG. 3, a schematic cross-sectional view of an electrically-powered tip-jet engine system 100 according to an embodiment of the invention. The tip-jet engine system 100 of FIG. 3 is a non-limiting example of a system based on a brushless DC motor design using outside rotors that ‘share’ a common rotor. The motor of the example is a synchronous motor powered by DC electricity via an inverter or switching power supply (neither is illustrated) which produces an AC electric current to drive each phase of the motor via a closed loop controller. The incoming air direction is indicated by arrow 14, while the thrust direction (which is the direction of travel) is indicated by arrow 15. The rotors 3, 4 are in the form of rotating disks connected to respective first and second fans 1, 2 to form respective first and second fan assemblies. The first fan assembly (comprising fan 1 and rotor 3), which is at the ‘front’ of the tip-jet engine system 100 as it travels its circumferential route around the rotor 130 is configured to rotate in the clockwise direction with respect to the thrust direction DT (indicated in FIG. 3 by arrow 15). The term ‘with respect to the thrust direction’ means when looking from the ‘rear’ of the tip-jet engine system 100. In accordance with the embodiments of the invention, the second fan assembly (comprising fan 2 and rotor 4) is configured to rotate in the counter-clockwise direction with respect to the thrust direction DT. The ‘configuring’ of the counter-rotating two fan assemblies means that the fan blades are installed so that both fan assemblies create thrust in the same thrust direction DT. In some embodiments, the order of the fan rotation directions can be the opposite, i.e., the ‘front’ fan assembly (comprising fan 1 and rotor 3) can be the one configured to turn counter-clockwise with respect to the thrust direction DT while the ‘rear’ fan assembly (comprising fan 2 and rotor 4) can be the one configured to turn clockwise with respect to the thrust direction DT. In both cases, the two fan assemblies are arranged coaxially, and each of the respective first and second fan assemblies of each tip-jet engine system 100 have substantially the same moment of inertia and rotate at substantially the same angular speed.

Each of the rotors 3, 4 comprises an array of permanent magnets 11. The common stator 5 comprises electromagnetic windings 10 in the form of coils. A support element 82 is one of three rigid members shown attaching the tip-jet engine system 100 to the helicopter rotor blade 18 (which can be the same as, or similar to, any of the rotor blades 117 shown in FIGS. 1 and 2). A rigid frame assembly can comprise support member 82 and stator 5. The other two support members, 8₁ and 8₃, support the rotating parts of the tip-jet engine system, including, respective motor rotors 3, 4 and respective rotating shafts 16, 17. Rotating shafts 16, 17 are supported, respectively, by main bearings 6. Thrust bearings 7 are disposed at least between support 8₁ and motor rotor 3, and between stator 5 and motor rotor 4; these thrust bearings 7 permit rotation between the rotating parts and the static parts, but they are designed to support a predominantly axial load along an axis parallel to the thrust direction indicated by arrow 15.

The tip-jet engine system 100 shown in FIG. 3 includes a shroud, or duct, 9. As is known in the art, a duct reduces losses in thrust from the tips of the fan blades, and varying the cross-section of the duct, e.g., as shown in FIG. 3, allows the designer to advantageously affect the velocity and pressure of the airflow according to Bernoulli's principle. However, use of a ducted fan reduce efficiency of the fan assemblies at cruising speeds. Thus, the decision whether to use ducted fan assemblies is a design choice to be made when practicing the invention. In embodiments without a duct, the design of the fans can be different. The use of a duct 9 enables the use of static guide vanes 12, implemented here as a guide-vane ring within the duct. Guide vanes, as is known in the art, can be useful for directing airflow into the second fan assembly. Cowlings 13 are fitted over the rotating parts of the fan assemblies in FIG. 3 for, inter alia, directing air flow, drag reduction, and protection of moving parts.

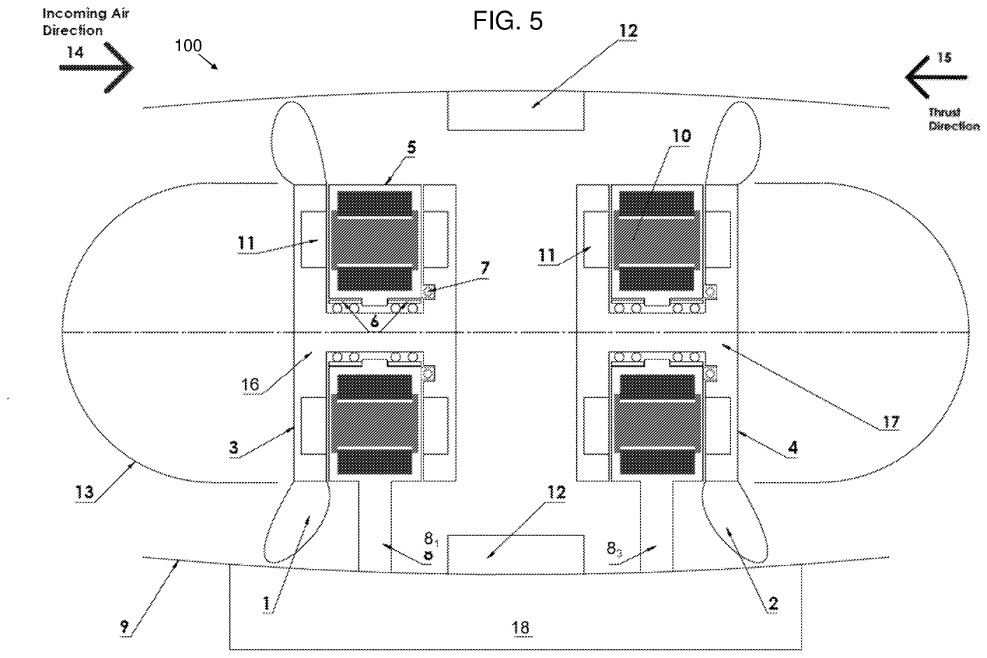

FIG. 4 illustrates another example of a tip-jet engine system 100, according to an embodiment of the invention. The tip-jet engine system 100 of FIG. 4 is a non-limiting example of a system based on a brushless DC motor design, based on an outer-rotor approach. Unlike the tip-jet engine system 100 of FIG. 3, each motor unit has a separate rotor, i.e., there are two motor units in the system, each one having a stator and a rotor. The skilled artisan will notice that the stator and rotor designs of FIG. 4 are very similar to those of FIG. 3, and in fact are the result of ‘splitting’ the common stator 5 of FIG. 3 into first and second stators 5₁, 5₂, and adding a second ring of permanent magnets 11 to each of the two respective rotors 3, 4 so as to have a ring of permanent magnets on either side of the first and second stators 5₁, 5₂. The support member 8₂ here supports both stators 5₁, 5₂, and guide vanes 12 are shown schematically as being much wider. The rest of the design of the tip-jet engine system 100 in FIG. 4 is similar to that of FIG. 3. The incoming air direction is again indicated by arrow 14, and the thrust direction is again indicated by arrow 15. The rotors 3, 4 are connected to respective first and second fans 1, 2 to form respective first and second fan assemblies. The first fan assembly (comprising fan 1 and rotor 3) is configured to rotate in the clockwise direction with respect to the thrust direction DT, and the second fan assembly (comprising fan 2 and rotor 4) is configured to rotate in the corresponding counter-clockwise direction, although in other embodiments the roles can be reversed. In both cases, the two fan assemblies are arranged coaxially, and each of the respective first and second fan assemblies of each tip-jet engine system 100 have substantially the same moment of inertia and rotate at substantially the same angular speed. Each of the rotors 3, 4 comprises permanent magnets 11 and each of the stators 5₁, 5₂ comprises electromagnetic windings 10 in the form of coils. Support members, 8₁ and 8₃, support the rotating parts of the tip-jet engine system 100, including, respective motor rotors 3, 4 and respective rotating shafts 16, 17. Rotating shafts 16, 17 are supported, respectively, by main bearings 6. Thrust bearings 7 are disposed at least between support 8₃ and motor rotor 3, and between stator 5 and motor rotor 4. The tip-jet engine system 100 shown in FIG. 4 also includes a duct 9, which enables the use of static guide vanes 12, implemented here as a guide-vane ring within the duct—the two fan assemblies of FIG. 4, like those of FIG. 3, are configured to operate together as a two-stage counter-rotating axial fan. Cowlings 13 are also fitted over the rotating parts of the fan assemblies in FIG. 4.

Referring now to FIG. 5, another example of a tip-jet engine system 100 is shown according to embodiments of the invention. The tip-jet engine system 100 of FIG. 5 is another non-limiting example of a system based on a brushless DC motor design. Key differences from FIG. 4 include: (i) there are two connected support frames 8, one per motor unit; (ii) the permanent magnets 11 are fewer but larger; (iii) the rotating elements 15, 16 are smaller than in FIG. 4, allowing the main bearings 6 to be placed at more optimal locations between the stators 5 and the respective rotors 3, 4; and (iv) the need for thrust bearings 7 is somewhat reduced. The rest of the design of the tip-jet engine system 100 in FIG. 5 is similar to that of FIG. 4. The incoming air direction is again indicated by arrow 14, and the thrust direction is again indicated by arrow 15. The rotors 3, 4 are connected to respective first and second fans 1, 2 to form respective first and second fan assemblies. The first fan assembly (comprising fan 1 and rotor 3) is configured to rotate in the clockwise direction with respect to the thrust direction DT, and the second fan assembly (comprising fan 2 and rotor 4) is configured to rotate in the corresponding counter-clockwise direction, although in other embodiments the roles can be reversed. In both cases, the two fan assemblies are arranged coaxially, and each of the respective first and second fan assemblies of each tip-jet engine system 100 have substantially the same moment of inertia and rotate at substantially the same angular speed. Each of the stators 5 comprises electromagnetic windings 10 in the form of coils. The tip-jet engine system 100 shown in FIG. 4 also includes a duct 9, which enables the use of static guide vanes 12, implemented here as a guide-vane ring within the duct—the two fan assemblies of FIG. 5, like those of FIGS. 3 and 4, are configured to operate together as a two-stage counter-rotating axial fan. Engine cowlings 13 are also fitted in FIG. 5.

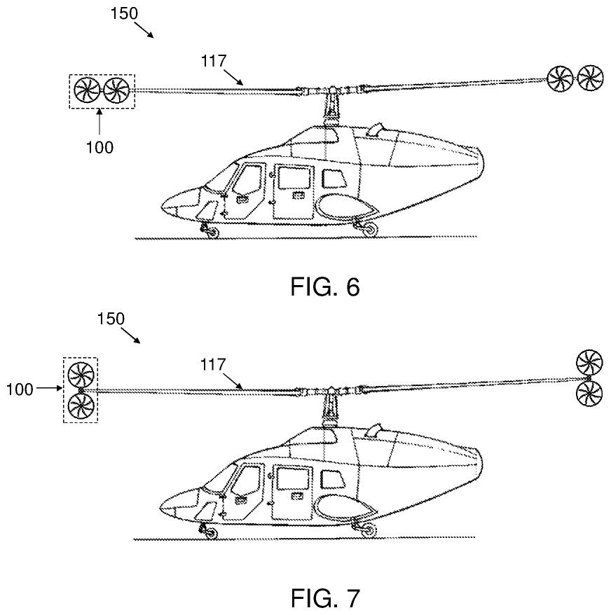

FIGS. 6 and 7 are schematic illustrations of helicopters 150 each having two rotor blades 117 and two corresponding tip-jet engine systems 100 in which the fan assemblies are not arranged coaxially. In FIG. 6, each of the tip-jet engine systems 100 comprises two motor units arranged side-by-side. Each of the respective two fan assemblies of each of the tip-jet engine systems 100 have substantially the same moment of inertia and are configured to rotate at substantially the same angular speed when powered. In FIG. 7, each of the tip-jet engine systems 100 comprises two motor units arranged such that one motor unit is disposed substantially atop the other. Each of the respective two fan assemblies of each tip-jet engine system 100 have substantially the same moment of inertia and are also configured to rotate at substantially the same angular speed.

In some embodiments, any of the fan assemblies, motor units or tip-jet engine systems described or illustrated hereinabove can be provided without fan ducts and, consequently, without guide vanes. In some embodiments there is no duct shell and the fans are replaced by two propellers designed accordingly.

### Example

In an example, a rotary-wing aircraft 150 is fitted with tip-jet engine systems 100. The helicopter 150 has four rotor blades 117 connected to a single rotor 130. Therefore four tip-jet engine systems 100 are deployed. The tip-jet engine systems 100 were required to create 60 kg of thrust, a requirement that was a key input to the design.

The following table shows ranges for values of design and operating parameters of one of the four tip-jet engine systems 100 based on the design criterion of 60 kg thrust. The table represents just one example of a combination of parameters, out of a potentially infinite number of combinations, and should therefore be viewed as an illustration of a suitable specification for a 60-kg system. In some cases, the parameter values shown have been calculated (e.g., electric power) and in other cases they reflect that design choices have also been factored in (e.g., physical dimensions of the tip-jet engine system).

| Parameters | Values | |
|---|---|---|
| Thrust | 60 | kg (specified) |
| Electric power (to motor) | 100-130 | kWₑ |
| Fan diameter | 0.4-0.5 | m |
| External system diameter | 0.45-0.55 | m |
| Electric motor diameter | 0.2-0.3 | m |
| Air mass-flow | 25-30 | kg/sec |
| Inflow velocity | 100-150 | m/sec |
| Air velocity increase | 15-30 | m/sec |
| Fan rotation speed | 9000-11,000 | rpm |
| Engine system length | 0.6 | m |
| Engine system mass | 15-20 | kg |

In another example, a much larger helicopter requiring, for example, thrust of 100-120 kg would require up to two times the electric power to the tip-jet engine systems, and tip-jet engines would be up to two times larger at least in terms of mass. The helicopter rotor blades could be 1.5 times longer with the same rotor blade tip velocity.

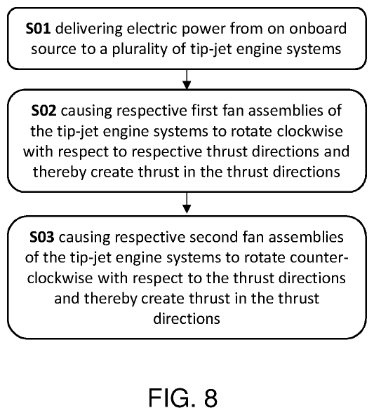

Referring now to FIG. 8, a method for operating an aircraft 150 comprising a plurality of electrically-powered tip-jet engine systems 100 mounted to respective rotor blades 117 of the aircraft 150 is disclosed. According to the method, each tip-jet engine system comprises first and second fan assemblies. The method, as illustrated in the flowchart of FIG. 8, can include the following steps:

Step S01, delivering electric power from on onboard source 180 to the plurality of tip-jet engine systems 100;

Step S02, causing respective first fan assemblies of the tip-jet engine systems 100 to rotate clockwise with respect to respective thrust directions DT and thereby create thrust in the thrust directions DT; and

Step S03, causing respective second fan assemblies of the tip-jet engine systems 100 to rotate counter-clockwise with respect to the thrust directions DT and thereby create thrust in the thrust directions DT.

According to the method, each of the respective first and second fan assemblies of each tip-jet engine system 100 have substantially the same moment of inertia and rotate at substantially the same angular speed.

In some embodiments of the method, the aircraft can additionally comprise an onboard electrical power source, a plurality of electrically conductive wires respectively disposed in aircraft rotor blades for delivering the electric power to the tip-jet engine systems, and a slip ring connected to the aircraft rotor for transmitting the electric power from the power source to the plurality of wires.

In some embodiments of the method, all of the steps of the method can be carried out simultaneously.

### Additional Discussion

A classical Tip Jet helicopter is designed as having a propulsion device installed at the tips of its rotor, applying thrust perpendicular to the rotor-blade, torqueing it and supplying the energy needed to hover, climb or fly forward.

Since the torque is applied directly to the rotor and not originated from the helicopter fuselage, there is no counter-torque applied on the fuselage and there is no need for a tail-rotor (or a tail).

In addition, the main rotor transmission is not needed and for a battery powered helicopter there is no need for main-engine installed in the fuselage. The whole propulsion system consists of a battery pack and a number of electric-tip-jet-engines equal to the number of rotor blades. All this reduces the empty-weight of the helicopter, allows more weight for the batteries and increases the payload or the endurance of the vehicle.

A simple electric-tip-jet will have a ducted-fan turned by an electric motor spinning at a rate of 10,000-15,000 RPM. If mounted at a tip of a rotor-blade turning at a rate of 300-600 RPM, a very large gyroscopic moment will develop, applying a twist moment around the rotor-blade longitudinal axis, probably destroying the rotor. One purpose of our invention is to eliminate this problem.

FIG. 3 describes a cross section of an electric-tip-jet-engine which is axisymmetric. Referring to FIG. 3, an example of one embodiment of an electric-tip-jet engine is illustrated. The engine is divided in two counter-rotating elements 16, 17, each having a magnet rotor section 3, 4 and an aerodynamic fan 1, 2. The moment of inertia and RPM of the two elements are identical or nearly identical and the two gyroscopic effects (created when the engine is installed at the tip of a turning rotor-blade) cancels each other, eliminating any substantial twisting of the rotor-blade.

Between the counter rotating fans a static guide vane ring 12 is installed, to redirect the air after first fan 1 compression. The second fan 2 is designed to accept the air after the first compression, creating a typical two stage counter rotating compressor (fan).

The magnetic rotors 3, 4 counter-rotate relative to a fixed electromagnets ring stators 5, installed at the center of the engine (a common stator for two counter-rotating rotors. The stator 5 contains a plurality of electromagnets 10 and the rotors 3, 4 contain a plurality of permanent magnets 11.

Each rotating element is equipped with main bearings 6 and pressure bearings 7 which are connected to the helicopter blade by connecting parts 8.

The incoming air 14 is guided through the outside duct shell 9 and the internal cowlings 13, the air is accelerated by the two counter rotating fans 3, 4 and creates thrust in direction 15. In an alternative embodiment there is no duct shell and the fans are replaced by two propellers designed accordingly.

Electric power is supplied to the electromagnets 10 through wires installed in the Helicopter rotor blade and a Slip-rings in the helicopter rotor shaft (not shown on the drawing).

Some of the inventive concepts related to the additional discussion include (but not exhaustively):

Inventive concept 1: An electric-tip-jet engine comprising two counter-rotating elements. The two elements having substantially the same moment of Inertia and configured to spin at the same RPM, thus eliminating the gyroscopic effect typical to a spinning mass at the tip of a turning rotor-blade.

Inventive concept 2: The electric -tip-jet engine of Inventive concept 1 wherein each counter-rotating-element comprises an aerodynamic fan and a disk containing a plurality of permanent magnets, using as electric motor rotor.

Inventive concept 3: The electric -tip-jet engine of Inventive concept 1 wherein each counter-rotating-elements is installed adjacent to common stator in which a plurality of electromagnetic coils is installed creating a typical axial flow electromagnetic motor (also called a Pancake motor).

Inventive concept 4: The electric -tip-jet engine of Inventive concept 1 wherein a static guide vanes ring is installed between the counter-rotating fans. the static vanes ring and the fans are designed to operate as a two stages counter-rotating axial fan.

Inventive concept 5: A method for propelling a helicopter or a VTOL vehicle with an electric-tip-jet -engine comprising two counter-rotating elements. The two elements having substantially the same moment of Inertia and the common stator is causing the two rotational elements to spin at the same RPM while operating.

Inventive concept 6: A vehicle adapted to flight comprising: A rotor, a plurality of Electric tip jet engines as described in Inventive concept 1 and one of Inventive concepts 2,3,4 installed at the tips of the rotor blades and an electric battery as the main power source.

Inventive concept 7: A vehicle, as claimed in Inventive concept 6 but with a hybrid electric reciprocating-engine, as main power source (instead of the battery).

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

In the description and claims of the present disclosure, each of the verbs, “comprise”, “include” and “have”, and conjugates thereof, are used to indicate that the object or objects of the verb are not necessarily a complete listing of members, components, elements or parts of the subject or subjects of the verb. As used herein, the singular form “a”, “an” and “the” include plural references unless the context clearly dictates otherwise.

For example, the term “a marking” or “at least one marking” may include a plurality of markings.

1. An electrically-powered tip-jet engine system for turning an aircraft rotor blade, the system comprising:
a. first and second fan assemblies having substantially the same moment of inertia and configured to rotate at the same angular speed, each fan assembly comprising a respective plurality of fan blades and a respective electric motor rotor; and
b. a rigid frame assembly comprising an electric motor stator assembly and configured for mounting to the aircraft rotor blade, wherein
i. the first fan assembly is effective to create thrust in a thrust direction by rotating clockwise with respect to the thrust direction, and
ii. the second fan assembly is effective to create thrust in the thrust direction by rotating counter-clockwise with respect to the thrust direction.

2. The tip-jet engine system of claim 1, wherein the rotation in opposing directions of the first and second fan assemblies is effective to eliminate gyroscopic effect on the aircraft rotor blade.

3. The tip-jet engine system of claim 1, wherein the first and second fan assemblies are disposed such that the respective motor rotors are adjacent to, and located on opposite sides of, the stator assembly, the stator assembly being configured as a common stator assembly for both fan assemblies.

4. The tip-jet engine system of claim 1, comprising two stator assemblies, each stator assembly being disposed adjacent to a respective one of the first and second fan assemblies so as to form respective first and second electric motor units.

5. (canceled)

6. (canceled)

7. (canceled)

8. (canceled)

9. (canceled)

10. (canceled)

11. An aircraft configured to carry passengers, comprising:
a. an onboard electrical power source;
b. an aircraft rotor comprising a plurality of aircraft rotor blades; and
c. a plurality of electrically-powered tip-jet engine systems for turning the aircraft rotor, each tip-jet engine system comprising:
(i) a rigid frame assembly mounted to a respective aircraft rotor blade and comprising an electric motor stator assembly, and
(ii) first and second fan assemblies having substantially the same moment of inertia and configured to rotate at the same angular speed, each fan assembly comprising a respective plurality of fan blades and a respective electric motor rotor, wherein:
A. the first fan assembly is effective to create thrust in a thrust direction by rotating clockwise with respect to the thrust direction, and
B. the second fan assembly is effective to create thrust in the thrust direction by rotating counter-clockwise with respect to the thrust direction.

12. The aircraft of claim 11, wherein the aircraft is a helicopter.

13. The aircraft of claim 11, wherein the aircraft is a VTOL fixed-wing aircraft.

14. The aircraft of additionally comprising:
d. a plurality of electrically conductive wires, each respective wire disposed in an aircraft rotor blade for delivering electricity to the tip-jet engine system; and
e. a slip ring connected to the aircraft rotor for transmitting electric power from the power source to the plurality of wires.

15. (canceled)

16. (canceled)

17. (canceled)

18. (canceled)

19. (canceled)

20. (canceled)

21. (canceled)

22. (canceled)

23. (canceled)

24. A method for operating an aircraft comprising a plurality of electrically-powered tip-jet engine systems mounted to respective rotor blades of the aircraft, each tip-jet engine system comprising first and second fan assemblies, the method comprising:
a. delivering electric power from on onboard source to the plurality of tip-jet engine systems;
b. causing respective first fan assemblies of the tip-jet engine systems to rotate clockwise with respect to respective thrust directions and thereby create thrust in the thrust directions; and
c. causing respective second fan assemblies of the tip-jet engine systems to rotate counter-clockwise with respect to the thrust directions and thereby create thrust in the thrust directions,
wherein the respective first and second fan assemblies of each tip-jet engine system have substantially the same moment of inertia and rotate at substantially the same angular speed.

25. The method of claim 24, wherein each of the fan assemblies (i) comprises a respective plurality of fan blades and a respective electric motor rotor, and (ii) is disposed adjacent to an electric motor stator assembly which is mounted to a respective aircraft rotor blade.

26. The method of lcaim 24, wherein the aircraft is a helicopter.

27. The method of claim 24, wherein the aircraft is a VTOL fixed-wing aircraft.

28-37. (canceled)
